(19) United States
(12) Patent Application Publication
(10) Pub. No.: US 2012/0008087 A1
(43) Pub. Date: Jan. 12, 2012

(54) Eyewear Support Device

(76) Inventor: David Bernhardt Franklin, Memphis, TN (US)

(21) Appl. No.: 12/956,093

(22) Filed: Nov. 30, 2010

Related U.S. Application Data
(60) Provisional application No. 61/362,551, filed on Jul. 8, 2010.

(51) Int. Cl. G02C 3/02

(52) U.S. Cl. 351/155

(57) ABSTRACT

An eyewear support device used to support and hold in place a pair of eyeglasses on a user's face. The device comprises a forehead panel having a front and rear surface, with a forwardly-extending flexible support arm protruding contiguously from the forehead panel. The support arm has a hook at the end configured to support a pair of eyeglasses, thereby preventing the eyeglasses from touching the user's face. The device may also have one or more cushions attached to the rear surface of the forehead panel. In another embodiment, the forehead panel comprises a forwardly-extending bridge or center section. A method of using the eyewear support device is also disclosed.

This application claims benefit of and priority to U.S. Provisional Application No. 61/362,551, filed Jul. 8, 2010, and is entitled to that filing date for priority. The specification, figures and complete disclosure of U.S. Provisional Application No. 61/362,551 are incorporated herein by specific reference for all purposes.

### FIELD

The present disclosure relates generally to an eyewear support device. More specifically, the present disclosure relates to a device used to support and hold in place a pair of eyeglasses on a person's face.

### BACKGROUND

Many individuals wear eyewear such as prescription eyeglasses to perform everyday tasks. Such eyewear is not optional and must be worn in order to perform such tasks. Eyeglasses typically consist of a frame that rests on the bridge of a person's nose as well as on the ears. In certain situations, such as when a person undergoes forehead flap nasal reconstruction surgery, there exists a need for such person to be able to wear eyeglasses without exerting pressure against the nose, the forehead, the cheeks, and other areas of the face and head where healing needs to occur without being touched by eyeglasses.

Forehead flap nasal reconstruction surgery is a medical procedure used to reconstruct deep and large nasal defects. During such procedure, a flap from the central forehead of the donor is incised, rotated 180 degrees and sutured into the nasal defect. The donor forehead defect is then sutured. Such procedure or surgery may be performed under local anesthesia as outpatient surgery. Advantages of the forehead flap technique include the fact that it provides a precise color and texture match to the missing nasal skin. One of disadvantages, however, is that the procedure is at least a multi-stage procedure. For example, the second stage may be four to six weeks after the initial cutting of the forehead flap.

During such stages of the forehead flap nasal reconstruction procedure, it is critical to maintain the blood supply to the forehead flap. Also, during the stages of the forehead flap nasal reconstruction procedure, it is critical that the sutures resulting from such procedure not be disturbed. Therefore, to accommodate the stages of this procedure as well as the healing and recovery process for a person who needs to wear eyeglasses throughout such procedure and process, there exists a need for a device which can support the eyeglasses on a person's face without such eyeglasses exerting pressure on the nose wherein the forehead flap lays or pressure on the area of the forehead wherein sutures are present. This is but one example of many uses that are possible.

Other situations which require medical attention and subsequent recovery time exist wherein there is a need for a person to be able to wear eyeglasses without exerting pressure against the nose and/or against certain areas of the face or head. Additional other situations may include any facial surgery where the eyeglasses must be kept off the nose, cheeks, ears, or other areas of the face or head during a healing process, including but not limited to burns and/or surgeries involving sinus surgery, plastic surgery, and/or facial reconstructive surgery.

### BRIEF SUMMARY

An eyewear support device is disclosed. In one exemplary embodiment, the device comprises a forehead panel which has a front and a rear surface. The forehead panel comprises a flexible support arm protruding contiguously from the forehead panel. The support arm comprises a hook configured to support a pair of eyeglasses. The device may further comprise a plurality of cushions attached to the rear surface of the forehead panel.

In another exemplary embodiment, the support arm has a step. In another embodiment, the forehead panel may comprise two apertures on each end of the forehead panel, which may be used to thread an elastic band with a clip to attach the device to a user's head. In a further embodiment, the cushions are adapted to prevent the panel from making contact with the user's forehead.

In yet another exemplary embodiment, the eyewear support device comprises a forehead panel having a front and rear surface. The forehead panel comprises a bridge having a flexible support arm protruding contiguously from the bridge. The support arm comprises a hook adapted to support a pair of eyeglasses. In one embodiment, a plurality of cushions may be attached to the rear surface of the forehead panel. The cushions are adapted to prevent the panel from making contact with the user's forehead.

A method of supporting and holding in place a pair of eyeglasses of a user's face also is disclosed. The method comprises the following steps: (a) obtaining an eyewear support device comprising a forehead panel having a front and rear surface, wherein the forehead panel comprises a flexible support arm protruding contiguously from the forehead panel, wherein the support arm comprises a hook adapted to support a pair of eyeglasses, further wherein a plurality of cushions are attached to the rear surface of the forehead panel; (b) securing the device to the user so that the plurality of cushions are adjacent to the forehead of the user; and (c) placing the eyeglasses on the hook.

A second method of supporting and holding in place a pair of eyeglasses on a user's face is also disclosed. The method comprises the following steps: (a) obtaining an eyewear support device, wherein the eyewear support device comprises a forehead panel having a front and rear surface, wherein the forehead panel comprises a bridge, wherein the bridge comprises a flexible support arm protruding contiguously from the bridge, further wherein the support arm comprises a hook configured to support a pair of eyeglasses; (b) securing the device to the user so that the forehead panel is adjacent to the forehead of the user; and (c) placing the eyeglasses on the hook. In one embodiment, a plurality of cushions are attached to the rear surface of the forehead panel.

### BRIEF DESCRIPTION OF THE DRAWINGS

The present disclosure will be better understood by reference to the following detailed description when considered in conjunction with the accompanying drawings wherein:

FIG. 1 is a perspective view of an eyewear support device with a head strap inserted according to an exemplary embodiment of the present invention.

FIG. 2 is a perspective view of the front surface of the eyewear support device of FIG. 1 without a head strap.

FIG. 3 is a perspective view of the rear surface of the eyewear support device of FIG. 1.

FIG. 4 is a front perspective view of the eyewear support device of FIG. 1.

FIG. 5 is a side perspective view of the eyewear support device of FIG. 1.

FIG. 6 is a back perspective view of the eyewear support device of FIG. 1.

FIG. 7 is a top perspective view of the eyewear support device of FIG. 1.

FIG. 8 is a bottom perspective view of the eyewear support device of FIG. 1.

FIG. 9 is a perspective view of an eyewear support device with a head strap inserted according to another exemplary embodiment of the present invention.

FIG. 10 is a front perspective view of the eyewear support device of FIG. 9.

FIG. 11 is a side perspective view of the eyewear support device of FIG. 9.

FIG. 12 is a bottom perspective view of the eyewear support device of FIG. 9.

FIG. 13 is a perspective view of one stage of forehead flap surgery where the forehead flap has been incised and undermined.

FIG. 14 is a perspective view of another stage of forehead flap surgery where the forehead flap having been rotated 180 degrees is sutured into the nasal defect and the donor forehead defect is sutured.

FIG. 15 is a perspective view of a healed flap five weeks after the initial surgery and prior to insetting.

FIG. 16 is a front perspective view of an eyewear support device in use according to one embodiment.

FIG. 17 is a front perspective view of an eyewear support device in use according to one embodiment.

FIG. 18 is a front perspective view of an eyewear support device in use according to another embodiment.

FIG. 19 is a front perspective view of an eyewear support device in use according to another embodiment.

FIG. 20 is a side perspective view of an eyewear support device in use according to another embodiment.

FIG. 21 is a side perspective view of an eyewear support device in use according to another embodiment.

### DETAILED DESCRIPTION

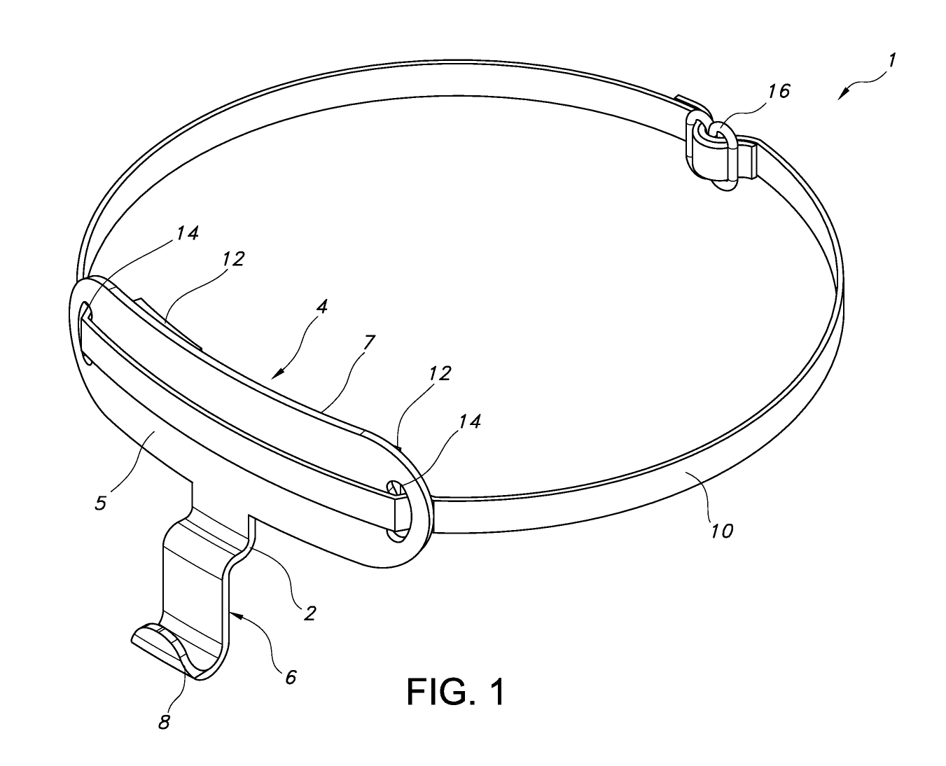

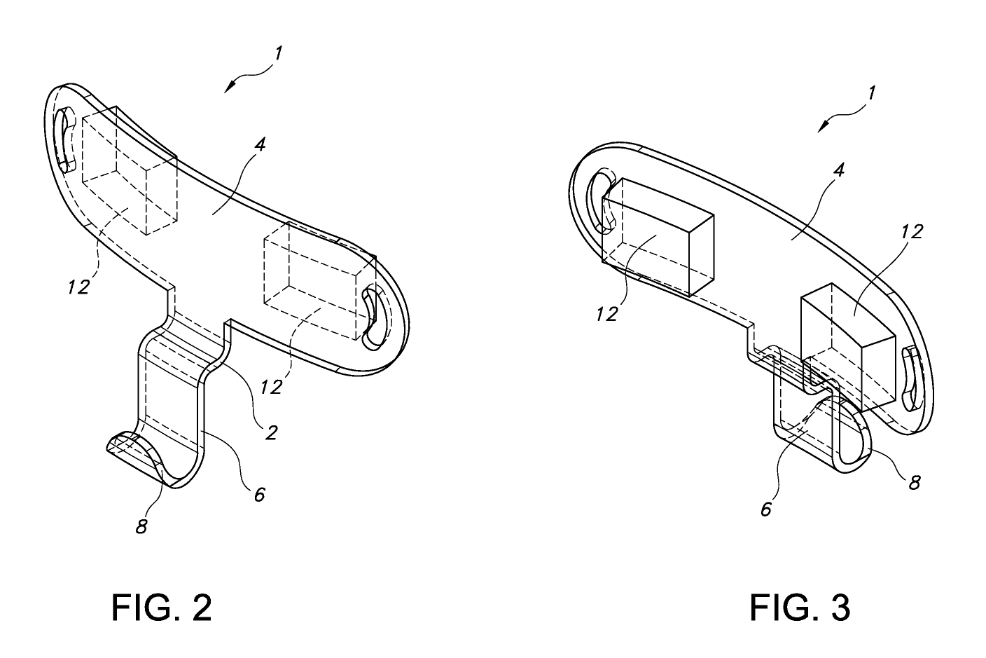

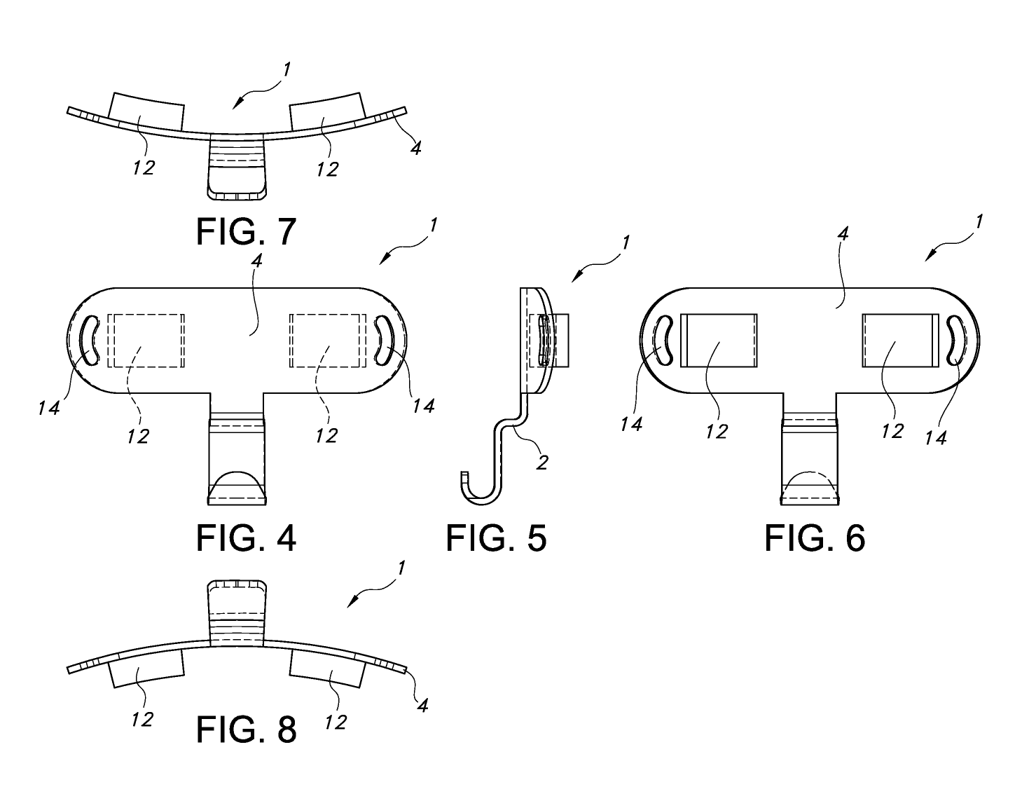

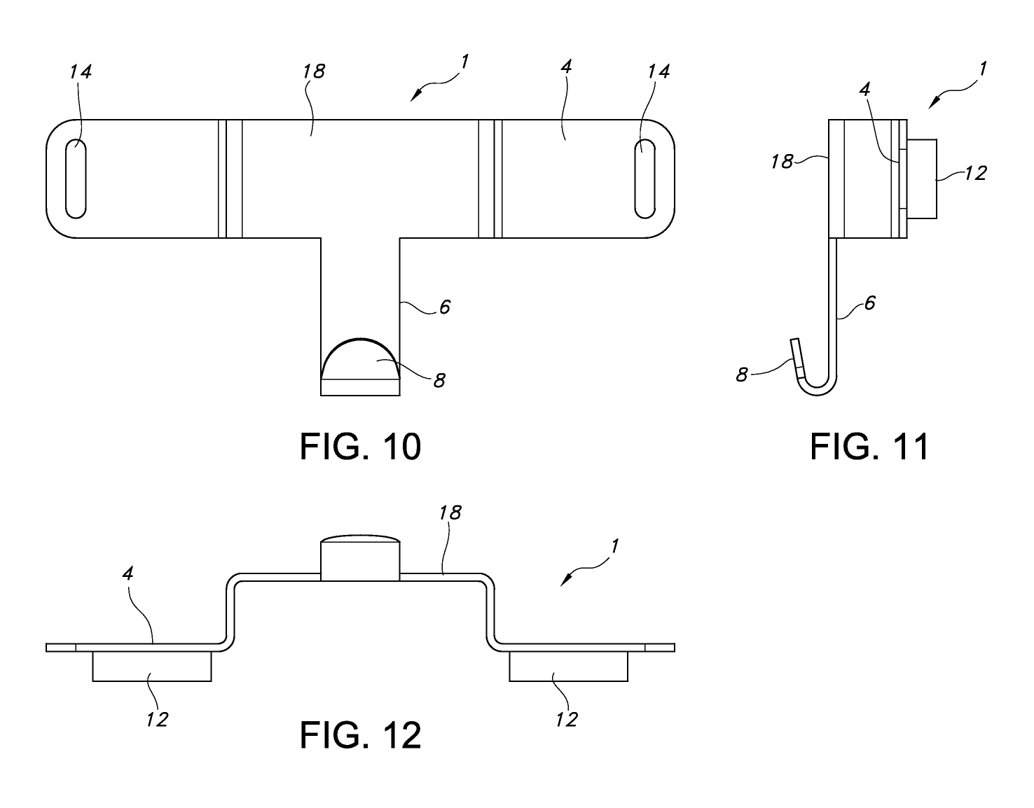

Referring to FIGS. 1 to 19, various embodiments of the present invention comprise an eyewear support device 1 which allows a person to wear his or her eyeglasses without allowing such eyeglasses to exert pressure on a person's nose. Further, eyewear support device 1 allows a person to wear his or her eyeglasses without allowing such eyeglasses to exert pressure against certain areas of the nose, the forehead, the cheeks, and all areas of the face and head, including ears, where healing needs to occur without being touched by eyeglasses.

In one embodiment, eyewear support device 1 is made of a lightweight, flexible metal, but any other flexible material, such as, but not limited to, plastic may be used. In one embodiment, as shown in FIGS. 1 to 8, eyewear support device 1 comprises a forehead panel 4 having a front surface 5 and rear surface 7. Forehead panel 4 comprises a support arm 6 protruding contiguously from forehead panel 4. In one embodiment, the support arm 6 comprises a step 2. Step 2 creates further distance between the user's face and the eyeglasses. At the end of support arm 6 is a hook 8. The eyeglasses rest on hook 8 as if hook 8 were the bridge of a user's nose. Support arm 6 and hook 8 are flexible, allowing device 1 to be modified and shaped according to the shape and size of the user's anatomy. In a further embodiment, forehead panel 4 comprises two or more cushions 12 on the rear surface 7 of forehead panel 4. Cushions 12 provide comfort as well as prevent panel 4 from making contact with the user's entire forehead. The figure shows two cushions, although a single cushion or more than two cushions may be used.

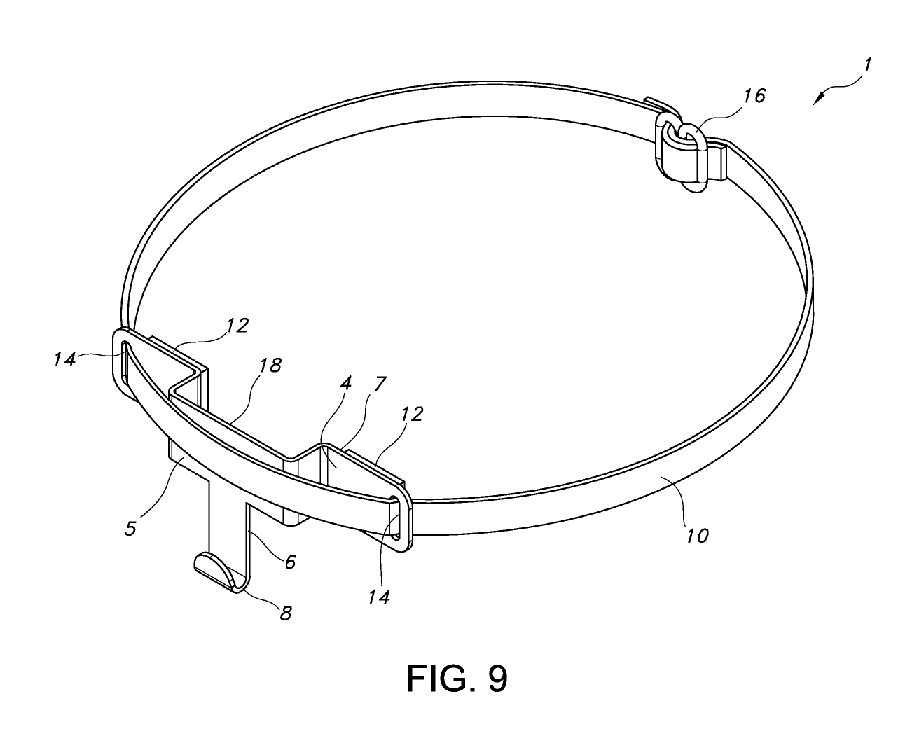

In another embodiment, as shown in FIGS. 9 to 12, eyewear support device comprises a forehead panel 4 having a front surface 5 and a rear surface 7. Forehead panel 4 comprises a support arm 6 protruding contiguously from forehead panel 4. At the end of the support arm 6 comprises a hook 8. Again, a pair of eyeglasses may rest on hook 8 as if hook 8 were the bridge of a person's nose. Support arm 6 and hook 8 may be flexible, allowing device 1 to be modified and shaped according to the shape and size of the user's anatomy. In one embodiment, forehead panel 4 comprises two cushions 12 on the rear surface 7 of forehead panel 4. As noted above, one, three or more cushions may be used. Further, in another exemplary embodiment, forehead panel 4 does not have cushions 12. Cushions 12 provide more comfort but are optional as long as device 1 supports a user's glasses and prevents the glasses from exerting pressure on the user's face.

In another exemplary embodiment of eyewear support device 1, forehead panel 4 comprises a bridge 18 to distance device 1 from the forehead, the nose, the cheeks, other areas of the face and head, including ears, where healing needs to occur without being touched by eyeglasses. The length of bridge 18 may range from one inch to one and one half inches but other lengths may be used as desired by one of skill in the art. The depth of bridge 18 may range from one-fourth inch to one-half inch but may be other depths may be used as desired by one of skill in the art.

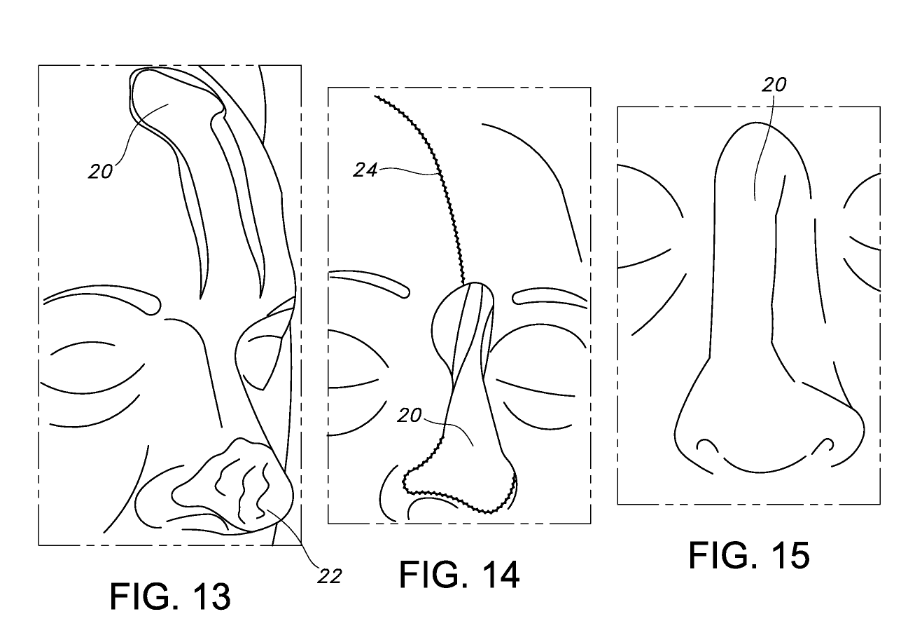

For exemplary purposes, eyewear support device 1 may be used by a person who will undergo forehead flap nasal reconstruction surgery and wear eyeglasses during such multistage medical procedure and subsequent recovery time. Referring now to FIGS. 13 to 15, forehead flap nasal reconstruction surgery is a medical procedure used to reconstruct deep and large nasal defects. During such procedure, a flap 20 from the central forehead of the donor (best seen in FIG. 13) is incised. Flap 20 will be used to reconstruct nasal defect 22. The flap 20 is then rotated 180 degrees and sutured into the nasal defect (best seen in FIG. 14). The donor forehead defect is then sutured 24. FIG. 15 depicts a healed flap 20 five weeks after the initial surgery and prior to insetting.

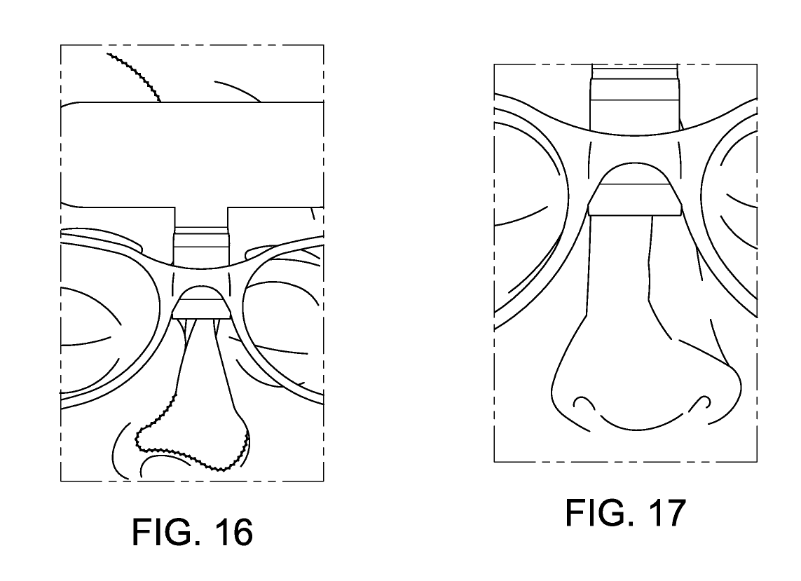

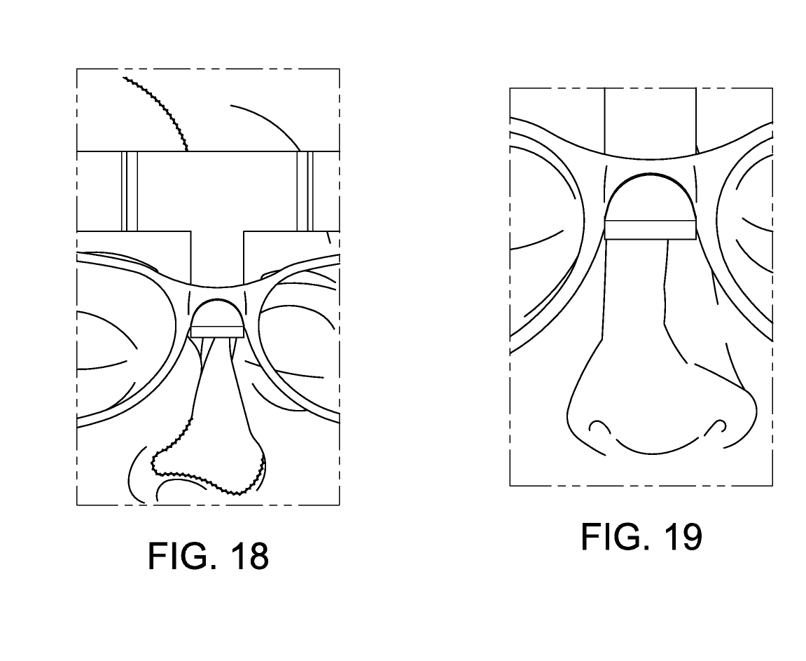

Cushions 12 prevent eyewear support device 1 from touching or making contact with the forehead, the cheeks, the nose, the ears and other areas of the face and head when eyewear support device 1 is in use, best seen in FIGS. 16 to 21. Cushions 12 may be spaced apart at a sufficient distance to prevent such contact. For example, referring to FIGS. 16 and 18, in one embodiment, cushions 12 are spaced apart at a sufficient distance to prevent eyewear support device 1 from disturbing flap 20 and/or sutures 24 that are present on the nose and forehead after the initial stage of forehead flap nasal reconstruction surgery. Referring now to FIGS. 17 and 19, in one embodiment, cushions 12 are spaced apart at a sufficient distance to prevent eyewear support device 1 from disturbing healed flap 20 that is present five weeks after the initial surgery and prior to insetting.

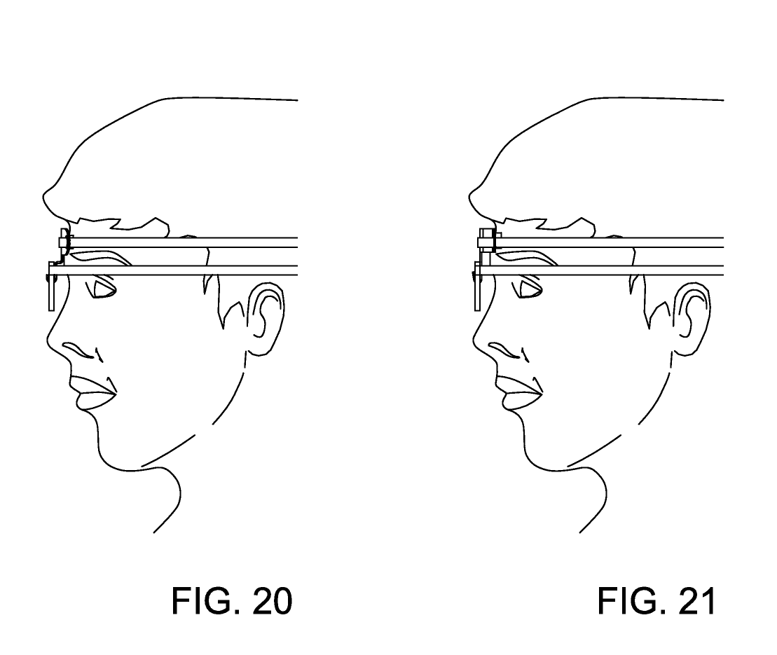

In another embodiment, eyewear support device 1 is secured to a person's forehead by the use of an elastic band 10 and clip 16, as seen in FIGS. 20 and 21. In one exemplary embodiment, in order to secure eyewear support device 1 to a person's forehead, forehead panel 4 may comprise one or more apertures 14 on each end of forehead panel 4. Elastic band 10 may be threaded through apertures 14 and along with clip 16 used to secure device 1 to a person's forehead. Other ways of securing eyewear support device 1 for use may be used as desired by one of skill in the art. For example, eyewear support device 1 may be secured to a person's forehead by use of a Velcro strap, or secured or clipped to a hat or other object worn on the head.

A method of supporting and holding in place a pair of eyeglasses on a user's face is also disclosed. The method comprises the following steps: (a) obtaining eyewear support device 1 which comprises a forehead panel 4 having a front 5 and rear surface 7, wherein the forehead panel 4 comprises a flexible support arm 6 protruding contiguously from the forehead panel 4, wherein the support arm 6 comprises a hook 8 adapted to support a pair of eyeglasses, wherein one or more cushions 12 may be attached to the rear surface 7 of the forehead panel 4; (b) securing the device 1 to the user so that the plurality of cushions 12 are adjacent to the forehead of the user; and (c) placing the eyeglasses on the hook 8.

A second method of supporting and holding in place a pair of eyeglasses on a user's face is also disclosed. The method comprises the following steps: (a) obtaining an eyewear support device 1, wherein the eyewear support device 1 comprises a forehead panel 4 having a front 5 and rear surface 7, wherein the forehead panel 4 comprises a bridge 18, wherein the bridge 18 comprises a flexible support arm 6 protruding contiguously from the bridge 18, wherein the support arm 6 comprises a hook 8 configured to support a pair of eyeglasses; (b) securing the device 1 to the user so that the forehead panel 4 is adjacent to the forehead of the user; and (c) placing the eyeglasses on the hook 8. In one embodiment, one or more of cushions 12 are attached to the rear surface 7 of the forehead panel 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

What is claimed is:

1. An eyewear support device, comprising:
a forehead panel having a front and a rear surface; and
a support arm protruding forward from the forehead panel, said support arm comprising a hook at the end.

2. The device of claim 1, wherein the support arm has a step.

3. The device of claim 1, wherein the forehead panel has one or more apertures on each end of the forehead panel, said apertures adapted to receive an elastic band.

4. The device of claim 1, further comprising one or more cushions on the rear surface of the forehead panel.

5. The device of claim 4, wherein the cushions are adapted to prevent the panel from making contact with a user's forehead.

6. The device of claim 1, wherein the support arm is contiguous with the forehead panel.

7. The device of claim 1, wherein the support arm is flexible.

8. The device of claim 1, wherein the hook is configured to support a pair of eyeglasses or eyewear.

9. An eyewear support device, comprising:
a forehead panel having a front and rear surface, wherein the forehead panel has a forward-extending bridge or center section;
a support arm protruding from the bridge, said support arm comprising a hook at the end.

10. The device of claim 9, further comprising one or more cushions on the rear surface of the forehead panel.

11. The device of claim 10, wherein the cushions are adapted to prevent the panel from making contact with the user's forehead.

12. The device of claim 9, wherein the support arm is flexible.

13. The device of claim 9, wherein the hook is configured to support a pair of eyeglasses or eyewear.

14. A method of supporting and holding in place a pair of eyeglasses on a user's face, the method comprising the steps of:
securing an eyewear support device to the user, the eyewear support device comprising a forehead panel having a front and rear surface, and a support arm protruding forward from the forehead panel, the support arm comprising a hook at the end; and
placing the nosepiece of a pair of eyeglasses or eyewear on the hook.

15. The method of claim 14, wherein the hook is flexible.

16. The method of claim 14, wherein the support arm is contiguous with the forehead panel.

17. The method of claim 14, wherein one or more cushions are affixed on the rear surface of the forehead panel.

18. The method of claim 14, wherein the forehead panel further comprises a forward extending bridge or center section, and the support arm protrudes forward from the bridge or center section.

19. The method of claim 17, wherein the device is secured so that the one or more cushions are adjacent to the user's forehead.
